(19) United States
(12) Patent Application Publication
(10) Pub. No.: US 2024/0430934 A1
(43) Pub. Date: Dec. 26, 2024

(54) COMMUNICATION CONTROL METHOD

(71) Applicant: KYOCERA Corporation, Kyoto (JP)

(72) Inventors: Masato FUJISHIRO, Yokohama-shi (JP); Mitsutaka HATA, Yokohama-shi (JP)

(73) Assignee: KYOCERA Corporation, Kyoto (JP)

(21) Appl. No.: 18/822,875

(22) Filed: Sep. 3, 2024

Related U.S. Application Data
(63) Continuation of application No. PCT/JP2023/007496, filed on Mar. 1, 2023.

(30) Foreign Application Priority Data
Mar. 2, 2022 (JP) 2022-032195

(51) Int. Cl. H04W 74/0808; H04W 72/0446

(52) U.S. Cl. CPC H04W 74/0808; H04W 72/0446

(57) ABSTRACT

In an aspect, a communication control method is a communication control method in a wireless communication system. The communication control method includes a step of transmitting, by a user equipment, communication profile information indicating a time period when communication with a base station is available to the base station, the user equipment having a power supply that generates power using energy harvesting. The communication control method includes a step of performing, by the base station, the communication with the user equipment based on the communication profile information.

### RELATED APPLICATIONS

The present application is a continuation based on PCT Application No. PCT/JP2023/007496, filed on Mar. 1, 2023, which claims the benefit of Japanese Patent Application No. 2022-032195 filed on Mar. 2, 2022. The content of which is incorporated by reference herein in their entirety.

### TECHNICAL FIELD

The present disclosure relates to a communication control method in wireless communication systems.

### BACKGROUND

In The Third Generation Partnership Project (3GPP), which is a standardization project for mobile communication systems, Passive IoT has been discussed (e.g., see Non-Patent Documents 1 to 3).

The passive IoT is a technology that supports, for example, ultra-low power devices with ultra-low costs.

### CITATION LIST

### Non-Patent Literature

Non-Patent Document 1: 3GPP Contribution RP-212688
Non-Patent Document 2: 3GPP Contribution RP-213368
Non-Patent Document 3: 3GPP Contribution RP-213369

### SUMMARY

In a first aspect, a communication control method is a communication control method in a wireless communication system. The communication control method includes a step of transmitting, by a user equipment, communication profile information indicating a time period when communication with a base station is available to the base station, the user equipment having a power supply that generates power using energy harvesting. The communication control method includes a step of performing, by the base station, the communication with the user equipment based on the communication profile information. In a second aspect, a communication control method is a communication control

method in a wireless communication system. The communication control method includes a step of transmitting, by a base station, information regarding a radio resource that communication is available without performing a random access procedure to a user equipment having a power supply that generates power using energy harvesting. The communication control method includes a step of performing, by the user equipment, the communication with the base station by using the radio resource without performing the random access procedure when received power of a received signal from the base station is equal to or greater than a determination RSRP threshold.

### BRIEF DESCRIPTION OF THE DRAWINGS

FIG. 1 is a diagram illustrating a configuration example of a wireless communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a wireless tag according to the first embodiment.

FIG. 5 is a diagram illustrating a configuration example of a protocol stack for a user plane according to the first embodiment.

FIG. 6 is a diagram illustrating a configuration example of a protocol stack for a control plane according to the first embodiment.

FIG. 7 is a diagram for explaining a problem in a passive IoT according to the first embodiment.

FIGS. 8A and 8B are diagrams for explaining a scenario a according to the first embodiment.

FIGS. 9A to 9C are diagrams for explaining a scenario b according to the first embodiment.

FIG. 10 is a diagram for explaining a scenario c according to the first embodiment.

FIG. 11 is a diagram illustrating a configuration example of a wireless communication system according to the first embodiment.

FIG. 12 is a diagram illustrating a configuration example of UE (user equipment) according to the first embodiment.

FIG. 13 is a diagram illustrating an operation example according to the first embodiment.

FIG. 14 is a diagram illustrating an operation example according to a second embodiment.

### DESCRIPTION OF EMBODIMENTS

In an aspect, a user equipment that obtains power using energy harvesting can appropriately communicate with a base station.

In an embodiment, a wireless communication system is described with reference to the drawings. In the description of the drawings, the same or similar parts are denoted by the same or similar reference signs.

### First Embodiment

### Configuration Example of Wireless Communication System

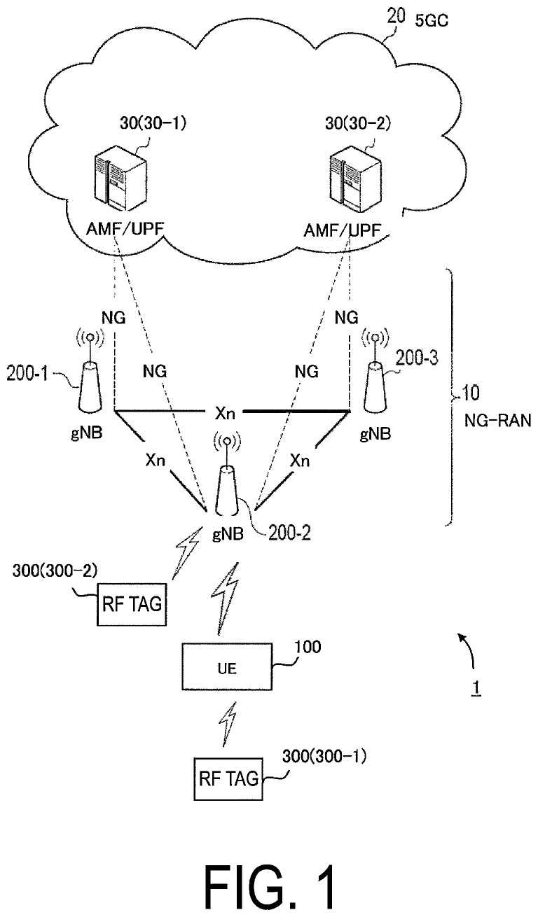

FIG. 1 is a diagram illustrating a configuration example of a wireless communication system according to a first embodiment. A wireless communication system 1 includes a mobile communication system that is the 5th Generation System (5GS) of the 3GPP standard. The description below takes the 5GS as an example of the mobile communication system, but a Long Term Evolution (LTE) system may be at least partially applied. A system of the sixth (6G) or subsequent generation system may be at least partially applied as the mobile communication system. Note that the wireless communication system 1 may be the mobile communication system.

The wireless communication system 1 includes a User Equipment (UE) 100, a 5G radio access network (Next Generation Radio Access Network (NG-RAN)) 10, and a 5G Core Network (5GC) 20, and a Radio Frequency (RF) tag 300. The 5GC 20 may be hereinafter simply referred to as a core network (CN) 20.

The UE 100 is a mobile wireless communication apparatus. The UE 100 may be any apparatus as long as it is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface, which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. Note that a “cell” is used as a term indicating a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) 30 and a User Plane Function (UPF). The AMF 30 performs various types of mobility controls and the like for the UE 100. The AMF 30 manages mobility of the UE 100 by communicating with the UE 100 by using Non-Access Stratum (NAS) signaling. The UPF controls data transfer. The AMF 30 and the UPF are connected to the gNB 200 via an NG interface, which is an interface between the base station and the core network.

An RF tag (or wireless tag, and may be referred to as a “wireless tag”) 300 is a wireless communication apparatus capable of wireless communication with the UE 100 or the gNB 200. The wireless tag 300 is also an information medium including a built-in memory to and from which data or the like is written or read using radio waves or electromagnetic fields. The wireless tag 300 is, for example, an Internet of Things (IoT) device that is extremely small, thin, lightweight, and low complexity.

### Configuration Example of UE

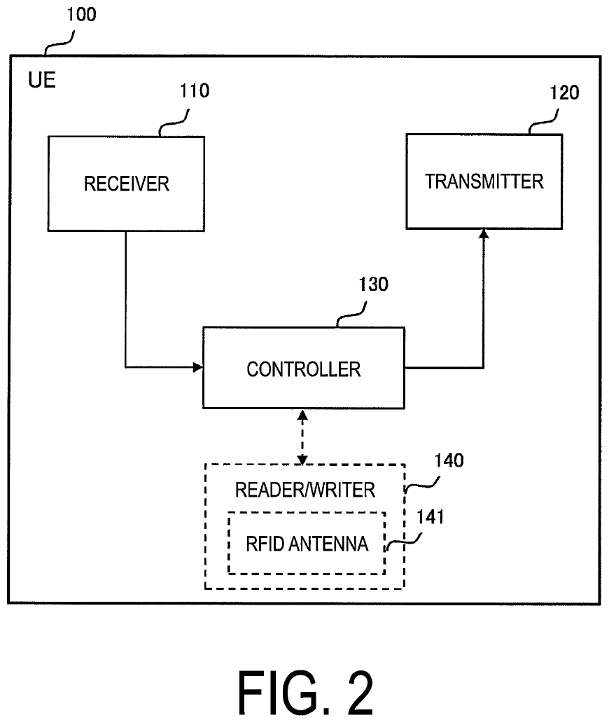

FIG. 2 is a diagram illustrating a configuration example of the UE 100 (user equipment) according to the first embodiment. The UE 100 includes a receiver 110, a transmitter 120, and a controller 130. The UE 100 may include a reader/writer 140. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. In the example described below, operations or processing in the UE 100 may be performed by the controller 130.

The reader/writer 140 includes a Radio Frequency identifier (RFID) antenna 141. The reader/writer 140 communicates with the wireless tag 300 via the RFID antenna 141 under control of the controller 130. The reader/writer 140 communicates with the wireless tag 300 using the RFID technology. The RFID technology is a technology for writing or reading data to and from the wireless tag 300 in a non-contact manner using radio waves or electromagnetic fields. The reader/writer 140 can also cause the wireless tag 300 to generate electric power using radio waves or electromagnetic fields transmitted from the RFID antenna 141. The UE 100 is capable of wireless communication with the wireless tag 300 via the reader/writer 140. Note that the reader/writer 140 may have only a reader function without a writer function.

Note that the reader/writer 140 can also perform wireless communication with the wireless tag 300 using a communication protocol in accordance with the 3GPP. In this case, instead of the RFID antenna 141, an antenna capable of transmitting and receiving a radio signal having a frequency used for the 3GPP may be included in the reader/writer 140. The reader/writer 140 can also perform wireless communication with the wireless tag 300 using backscattering (or backward scattering). In this case, an antenna capable of transmitting and receiving a frequency signal used in the backscattering may be included in the reader/writer 140. Note that backscattering is described in detail later.

### Configuration Example of gNB

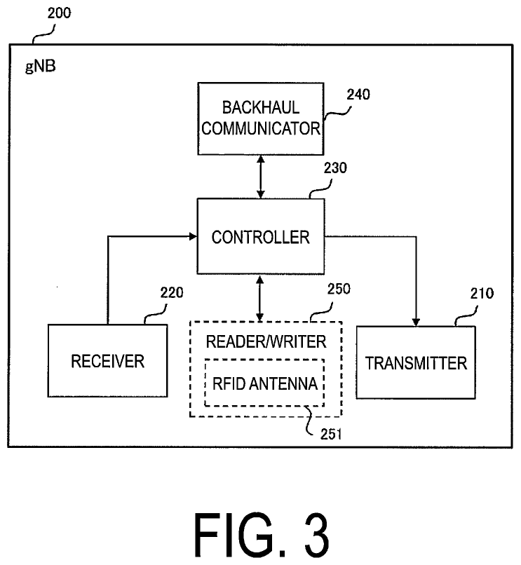

FIG. 3 is a diagram illustrating a configuration example of the gNB 200 (base station) according to the first embodiment. The gNB 200 includes a transmitter 210, a receiver 220, a controller 230, and a backhaul communicator 240. The gNB 200 may include a reader/writer 250. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing in the gNB 200 may be performed by the controller 230.

The backhaul communicator 240 is connected to a neighboring base station via an Xn interface, which is an inter-base station interface. The backhaul communicator 240 is connected to the AMF 30/UPF via the NG interface between the base station and the core network. Note that the gNB 200 may include a Central Unit (CU) and a Distributed Unit (DU) (i.e., functions are divided), and the two units may be connected via an F1 interface, which is a fronthaul interface.

The reader/writer 250 includes an RFID antenna 251. The reader/writer 250 communicates with the wireless tag 300 via the RFID antenna 251 under control of the controller 230. The reader/writer 250 writes and reads data to and from the wireless tag 300 in a non-contact manner using radio waves or electromagnetic fields transmitted from the RFID antenna 251. The reader/writer 250 can also cause the wireless tag 300 to generate electric power using radio waves or electromagnetic fields transmitted from the RFID antenna 251. The gNB 200 is capable of wireless communication with the wireless tag 300 via the reader/writer 250. Note that the reader/writer 250 may have only the reader function without the writer function.

Note that the reader/writer 250 can also perform wireless communication with the wireless tag 300 using a communication protocol in accordance with the 3GPP. In this case, instead of the RFID antenna 251, an antenna capable of transmitting and receiving a radio signal having a frequency used for the 3GPP may be included in the reader/writer 250. The reader/writer 250 can also perform wireless communication with the wireless tag 300 using backscattering. In this case, an antenna capable of transmitting and receiving a frequency signal used in the backscattering may be included in the reader/writer 250.

### Configuration Example of Wireless Tag

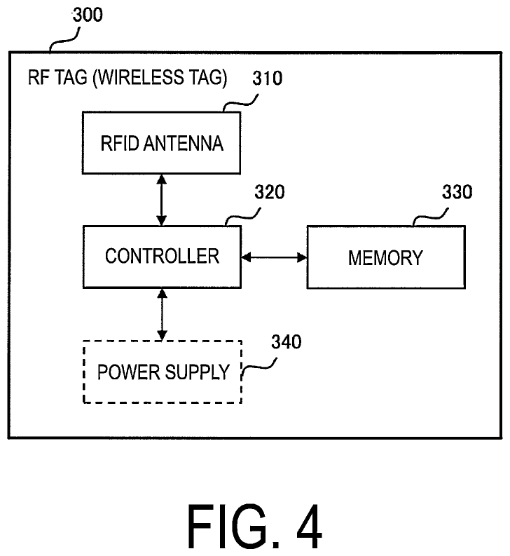

FIG. 4 is a diagram illustrating a configuration example of the wireless tag 300 according to the first embodiment. The wireless tag 300 includes an RFID antenna 310, a controller 320, and a memory 330. The wireless tag 300 may include a power supply 340.

The RFID antenna 310 performs wireless communication with the UE 100 or the gNB 200 using the RFID technology. As described above, the RFID technology includes a radio wave type and an electromagnetic induction type.

The radio wave type is a type of transmitting energy and signals using radio waves. In this case, the RFID antenna 310 receives radio waves transmitted from the UE 100 or the gNB 200, and a rectifier circuit provided in the RFID antenna 310 outputs part of the radio waves as DC power supply to the controller 320. This causes the controller 320 to operate. The RFID antenna 310 converts the received radio wave into a reception signal by a demodulation circuit or the like provided in the RFID antenna 310, and outputs the reception signal to the controller 320. Note that the RFID antenna 310 converts a transmission signal received from the controller 320 into a radio signal by a modulation circuit or the like provided in the RFID antenna 310, and transmits the radio signal to the UE 100 or the gNB 200. In this case, the RFID antenna 310 may transmit the radio signal by using a reflected wave of a received radio wave received from the UE 100 or the gNB 200.

The electromagnetic induction type is a type of causing an antenna coil to generate an electromagnetic field by electromagnetic induction and transmitting energy and signals. For the electromagnetic induction type, the RFID antenna 310 is a loop coil antenna. Both the RFID antenna 141 in the UE 100 and the RFID antenna 251 in the gNB 200 are loop coil antennas. The electromagnetic induction type is similar to and/or the same as the radio wave type in that power supply to the controller 320 is obtained by a rectifier circuit, a reception signal is obtained by a demodulation circuit, and a reflected wave may be used.

The controller 320 receives a reception signal from the RFID antenna 310. For example, the controller 320 writes data included in the reception signal to the memory 330 in accordance with indication information included in the reception signal. The controller 320 reads data from the memory 330 in accordance with the indication information included in the reception signal, for example. The controller 320 outputs a transmission signal including the read data to the RFID antenna 310. In the example described below, operations or processing in the wireless tag 300 may be performed by the controller 320.

The memory 330 stores an identifier of the wireless tag 300 (or identification information of the wireless tag 300. Hereinafter, the “identifier” and the “identification information” are not distinguished form each other in some cases), data, and the like. The memory 330 of the wireless tag 300 may adopt the Electronic Product Code (EPC) Class 1 Generation 2 (GEN2) standard conforming to ISO/IEC 18000-63. The memory 330 of the EPC GEN2 standard has four memory areas of a USER memory, a Tag ID (TID) memory, an EPC memory, and a RESERVED memory. The USER memory is an area that can be freely written to and read from by a user using the wireless tag 300. The TID memory is an area that a manufacturer, model information, and the like of the wireless tag 300 are written. The TID memory is a readable and non-writable area. The EPC memory is an area that the identifier of the wireless tag 300 is written. The RESERVED memory is an area that password information of the wireless tag 300 is written. The password information includes password information used to lock writing to the wireless tag 300 and password information used to Kill the wireless tag 300.

The power supply 340 is, for example, a power supply using energy harvesting. An environment for harvesting includes heat, vibration, motion, light, wind, radio wave, or biotechnology. The energy harvesting is a power generation method in which an electromotive force is obtained from the surrounding environment as described above. The energy harvesting is different from a power generation method using a battery such as a secondary battery. However, the wireless tag 300 may be equipped with a battery to generate power by itself like an active tag. For this reason, the power supply 340 may be a battery power supply.

Note that the wireless tag 300 may have only the reader function of reading data or the like from the memory 330 without the writer function of writing data or the like to the memory 330.

The wireless tag 300 can also perform wireless communication with the UE 100 or the gNB 200 using a communication protocol in accordance with the 3GPP. In this case, instead of the RFID antenna 310, an antenna capable of transmitting and receiving a radio signal having a frequency used for the 3GPP may be included in the wireless tag 300.

Hereinafter, a communication method of the wireless tag 300 is described as using the RFID technology, but is not limited thereto. For example, the communication method of the wireless tag 300 may use a 3GPP-compliant communication protocol. The wireless tag 300 may perform communication by using backscattering.

### Protocol Stack

A configuration example of the protocol stack is described. Here, a configuration example of the protocol stack in the UE 100, the gNB 200, and the AMF 30 other than the wireless tag 300 is described.

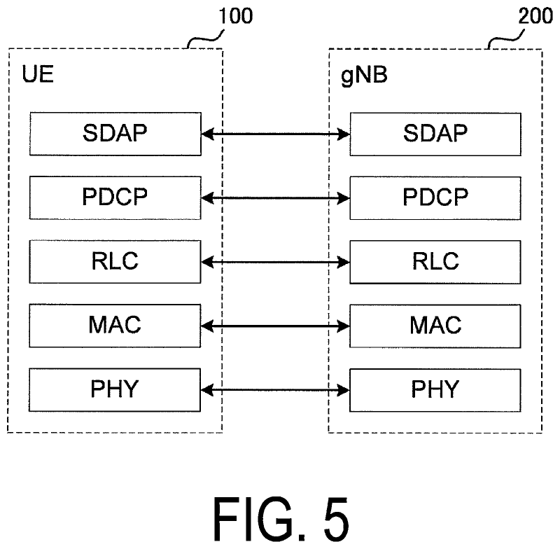

FIG. 5 is a diagram illustrating a configuration example of a protocol stack of a radio interface of a user plane handling data.

The radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

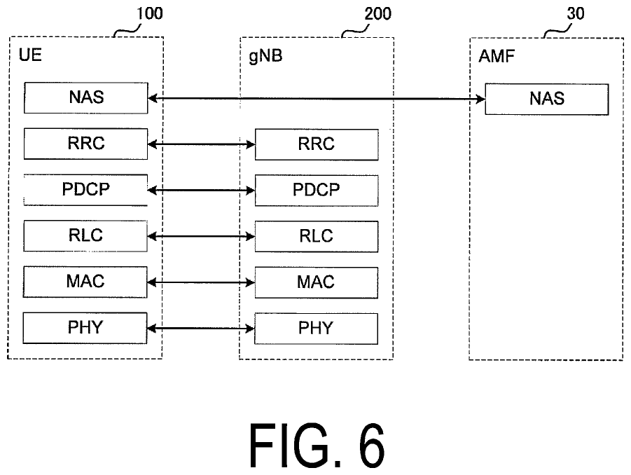

FIG. 6 is a diagram illustrating a configuration example of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 5.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is positioned upper than the RRC layer, performs session management, mobility management, and the like. NAS signaling is transmitted between the NAS of the UE 100 and the NAS of the AMF 30. Note that the UE 100 includes an application layer other than the protocol of the radio interface. A layer lower than the NAS is referred to as Access Stratum (AS).

### Passive IoT

The passive IoT is a technology that supports, for example, ultra-low power devices with ultra-low costs. Hereinafter, a device supporting the passive IoT may be referred to as a “passive IoT device”. The wireless tag 300 is an example of the passive IoT device.

The passive IoT device supports an ultra-low power device. Due to the low power consumption of the passive IoT, the passive IoT device may not need to use a battery or may use the energy harvesting.

Even the passive IoT devices may be equipped with a power supply. However, even such a case can be realized by a small-capacity battery and/or the energy harvesting on the premise of low power consumption, and thus low cost can be realized as compared with a device using a large-capacity battery.

On the other hand, since the passive IoT device performs communication using low power as compared with the UE 100 of the 5G system, a coverage range is narrow. A communication time is limited and an amount of data that can be transmitted and received at a time is small. In the passive IoT, interference may occur when multiple passive IoT devices communicate at the same time. Therefore, in the passive IoT, communication may be unstable and irregular.

The passive IoT may target the RFID, for example. Types of the RFID include a passive tag, an active tag, and a semi-passive tag (or a semi-active tag). The passive tag is a wireless tag that uses radio waves from a reader as a power supply. The passive tag is assumed to be mainly used for the passive IoT. The active tag is a wireless tag that uses a battery built in the wireless tag as a power supply. The semi-passive tag is a wireless tag that normally operates as a passive tag and operates as an active tag in response to a request from a reader. The passive IoT may target, for example, the semi-passive tag or the active tag.

Targets for the passive IoT include the backscattering, for example. The backscattering refers to reflection of a radio wave, a particle, or a signal back to a direction from which the radio wave, the particle, or the signal came. As described above, the backscattering in the passive IoT is used in the communication method using the reflected wave. The wireless tag 300 can modulate a reflected wave to transmit data by using the reflected wave.

Further, the targets for the passive IoT include the energy harvesting, for example. As described above, the energy harvesting is the power generation in which power is obtained from the environment. For example, in the energy harvesting, energy such as vibration or heat is converted into electrical energy to generate power. The energy harvesting may include solar panels or windmills. The low power consumption of the passive IoT allows the energy harvesting to be used as a power supply. Unlike a battery, the energy harvesting does not need to be charged or replaced, and thus can operate for a long time without maintenance.

### Problem of Passive IoT

When the passive IoT can be accommodated in a mobile communication system conforming to the 3GPP, for example, the passive IoT device can be managed also in the NG-RAN 10 or the CN 20.

However, when the passive IoT is accommodated in the mobile communication system, some problems may be considered.

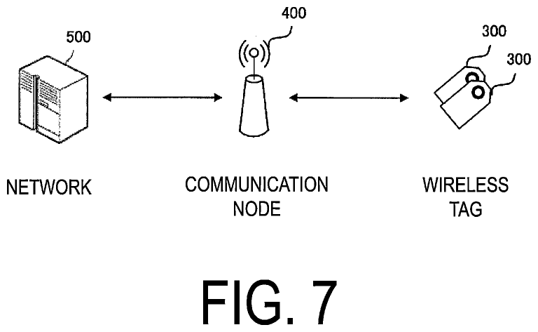

FIG. 7 is a diagram for explaining a problem in the passive IoT according to the first embodiment. In FIG. 7, a network 500 and a communication node 400 are included in the mobile communication system conforming to the 3GPP. The communication node 400 is a node that has the reader/writer function and communicates with the wireless tag 300. The communication node 400 may be the UE 100 or the gNB 200. On the other hand, the network 500 includes apparatuses communicating with the communication node 400. The network 500 is the CN 20 or the gNB 200.

When viewed from the network 500 (CN 20 or gNB 200), a problem is whether the wireless tag 300 is managed as a wireless tag or the UE 100. In the network 500, when the wireless tag 300 can be managed as the UE 100, the wireless tag 300 can be also handled in the same manner as the UE 100.

A problem is also whether the reader function (and/or writer function) is performed by the UE 100 or the gNB 200. Not only the UE 100 but also the gNB 200 can directly communicate with the wireless tag 300.

A further problem is whether the link between the communication node 400 and the wireless tag 300 uses existing specifications such as the RFID or uses the 3GPP-compliant communication protocol. Alternatively, a problem is whether a 3GPP-compliant communication band is used or a communication band for RFID (13.56 MHz band, 900 MHz band, or the like) is used.

As described above, there are several problems in order to accommodate the passive IoT in the mobile communication system. It will be understood that all or part of the above-described problems can be solved in the embodiments described below.

### Passive IoT Scenario

As scenarios in which passive IoT is used, the following three scenarios (scenario a, scenario b, and scenario c) are assumed. Note that although the communication node 400 is present in the three scenarios, the communication node 400 may be, for example, either the UE 100 including the reader/writer 140 or the gNB 200 including the reader/writer 250.

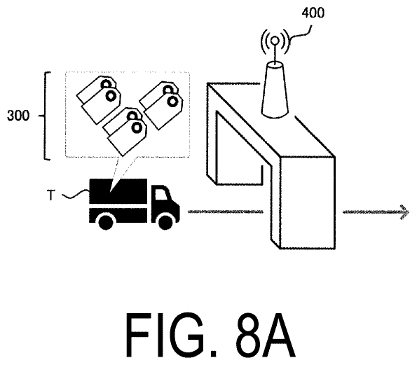

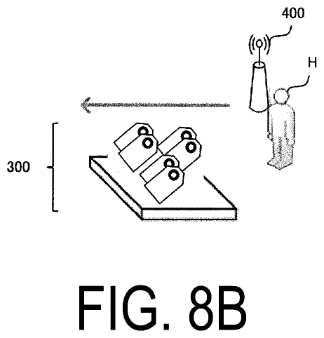

FIGS. 8A and 8B are diagrams for explaining the scenario a according to the first embodiment. The scenario a is, for example, a scenario in which the passive IoT is locally used.

As illustrated in FIG. 8A, when the wireless tag 300 loaded on a moving object such as a truck T (or a pallet) passes through a gate, the communication node 400 detects the wireless tag 300. The wireless tag 300 may be attached to each product. The wireless tag 300 may be attached to each pallet accommodating products. For example, the communication node 400 provided to a main gate of a factory detects the wireless tag 300, which enables management of products shipped from the factory or management of parts entering the factory.

An example of FIG. 8B is an example in which a moving object (e.g., a human H or a moving vehicle) moves the communication node 400 to detect the wireless tag 300 loaded on a fixed object (e.g., a pallet). The wireless tag 300 may be attached to each product. The wireless tag 300 may be attached to each pallet. The detection by the wireless tag 300 enables, for example, products loaded on a pallet to be managed.

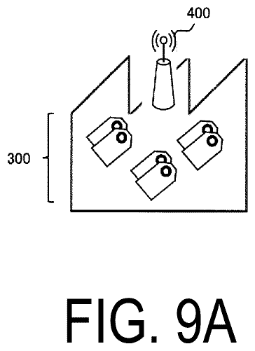

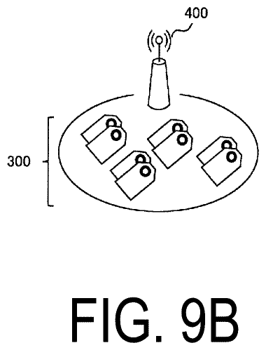

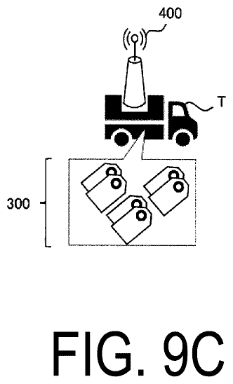

FIGS. 9A to 9C are diagrams for explaining the scenario b according to the first embodiment. The scenario b is a scenario for managing the wireless tag 300 existing in a certain location. The location may be a factory (or warehouse) (FIG. 9A), a particular area (FIG. 9B), or a load of the truck T (FIG. 9C). The communication node 400 manages the wireless tag 300 existing in the location, which enables inventory management of products or parts in the factory, management of products or part loaded on the truck T, and the like.

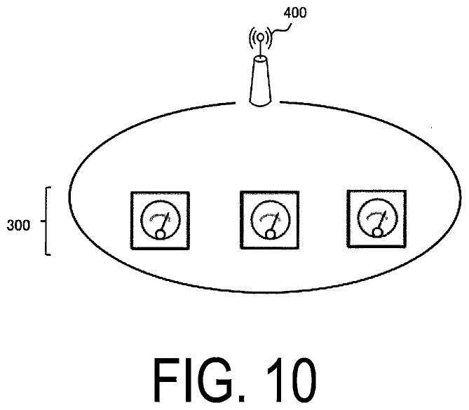

FIG. 10 is a diagram for explaining the scenario c according to the first embodiment. The scenario c is a scenario in which the wireless tag 300 disposed or existing in a certain location continuously or periodically reads a measurement value. For example, a thermometer and the wireless tag 300 connected to the thermometer are disposed in a site or a pasture. The wireless tag 300 can acquire a measurement value (temperature information) from the thermometer. Then, the communication node 400 continuously or periodically reads the measurement value from the wireless tag 300, which enables temperature management in the site, the pasture, or the like.

### Communication Control Method According to First Embodiment

A communication control method according to the first embodiment is described.

In the first embodiment, a case is described in which the communication node 400 is the UE 100 and the network 500 is the gNB 200. Furthermore, the first embodiment describes a case in which the UE 100 is the wireless tag 300.

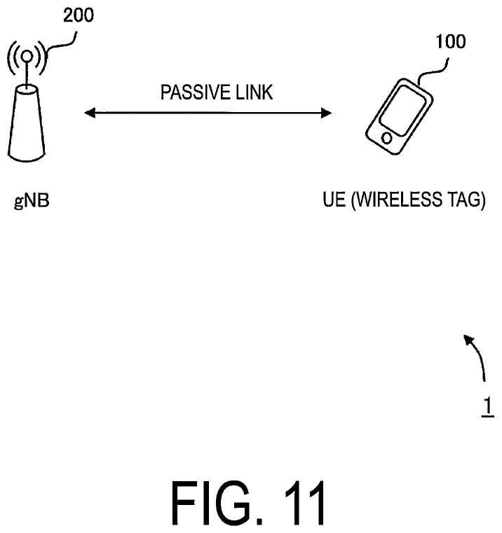

FIG. 11 is a diagram illustrating a configuration example of the wireless communication system 1 according to the first embodiment. As illustrated in FIG. 11, the gNB 200 can communicate with the UE 100, which is also the wireless tag 300, to read data stored in the UE 100 (which may be tag information, for example) from the UE 100.

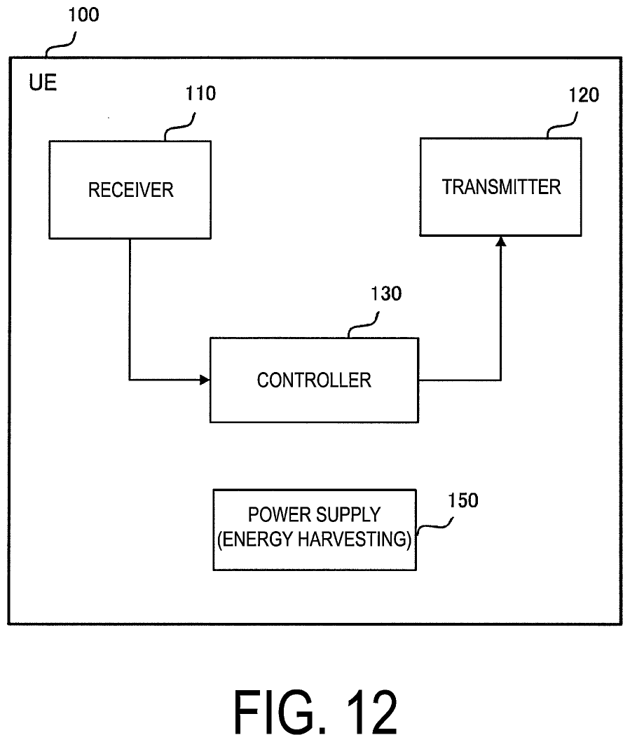

Here, the UE 100 has a power supply that generates power using the energy harvesting. FIG. 12 is a diagram illustrating a configuration example of the UE 100 according to the first embodiment. As illustrated in FIG. 12, the UE 100 includes a power supply 150. The power supply 150 is a power supply that generates power using the energy harvesting. Therefore, the UE 100 can communicate with the gNB 200 with the electric power of the UE 100 itself.

The UE 100 does not use a battery such as a secondary battery. As such, the UE 100 operates as a passive IoT device. Hereinafter, a UE operating as a passive IoT device may be referred to as a “PIOT UE”. Note that the UE 100 (PIOT UE) may operate using the energy harvesting and an auxiliary secondary battery.

Referring back to FIG. 11, a passive link is established between the gNB 200 and the PIOT UE 100. The passive link is, for example, a communication link between the gNB 200 and the wireless tag (PIOT UE 100). The passive link illustrated in FIG. 11 uses a communication protocol conforming to the 3GPP. Therefore, the reader/writer 250 is not provided in the gNB 200. The passive link uses a licensed band conforming to the 3GPP.

### Problem of First Embodiment

Under such premises, the first embodiment has the following problems.

That is, the PIOT UE 100 uses the energy harvesting. Therefore, the PIOT UE 100 is affected by the surrounding environment in terms of obtaining electric power. A magnitude of the electric power is smaller than that of the battery. Therefore, in the PIOT UE 100, the power supply may not be stable, and its capacitance may be limited.

The PIOT UE 100 also has a transmit power smaller than the UE using the battery. Therefore, the PIOT UE 100 may perform communication only in a small area (or a localized area) compared to the UE using the battery.

Further, the PIOT UE 100 may take time to obtain the electric power needed for communication (i.e., in charging). A charging time depends on the type of energy harvesting.

Moreover, the PIOT UE 100 cannot perform communication during charging. Furthermore, the PIOT UE 100, when being charged and then discharged, cannot perform communication.

In the 3GPP, the specifications of Discontinuous Reception (DRX) (or extended DRX (eDRX)) technology have been drafted. The DRX is a technology to stop transmission and reception of a radio signal for a time period during which a paging signal is not received. This can reduce a power consumption of the UE and extend a battery life of the UE. Therefore, it can be said that the purpose of the DRX is to reduce the power consumption of the UE with limited battery capacity and extend the battery life.

On the other hand, the PIOT UE 100 using the energy harvesting is assumed to intermittently operate such that communication is available for a certain time period and not available for other time periods. The energy harvesting is a technique different from the DRX in that the intermittent operation is performed that has the communication available time period and the communication not available time period.

Therefore, the problem of the first embodiment is that even the UE (PIOT UE) 100 generating power using the energy harvesting can appropriately communicate with the gNB 200.

Therefore, the PIOT UE 100 transmits the time period when communication with the gNB 200 is available to the gNB 200. To be more specific, first, the user equipment (e.g., the PIOT UE 100) transmits communication profile information indicating a time period when communication with the base station (e.g., a gNB 200) is available to the base station, the user equipment having the power supply (e.g., the power supply 150) that generates power using energy harvesting. Second, the base station performs the communication with the user equipment based on the communication profile information.

As described above, for example, the gNB 200 can grasp the time period when communication with the PIOT UE 100 is available, based on the communication profile information. Therefore, the gNB 200 can decide a transmission timing appropriate for the PIOT UE 100 or the like. Therefore, the PIOT UE 100 can appropriately communicate with the gNB 200.

### Operation Example According to First Embodiment

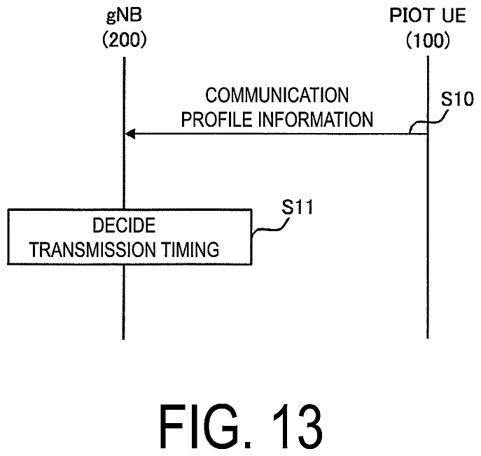

FIG. 13 is a diagram illustrating an operation example according to the first embodiment.

As illustrated in FIG. 13, in step S10, the PIOT UE 100 transmits the communication profile information indicating a time period when communication with the gNB 200 is available to the gNB 200 (or the CN 20). The PIOT UE 100 transmits the communication profile information by transmitting either an RRC message including the communication profile information or a NAS message including the communication profile information. The communication profile information may be transmitted by way of a MAC Control Element (MAC CE) or Uplink Control Information (UCI).

First, the communication profile information may be a communication available time period representing a time period from when the communication ends in the PIOT UE 100 to when next communication is available. For example, the PIOT UE 100 may calculate the communication available time period based on a charging time required for charging. The communication available time period may be the charging time.

Second, the communication profile information may be a sustainable time period representing a communication time period sustainable by the PIOT UE 100 in one communication. For example, the PIOT UE 100 may use a discharging time calculated from a battery capacity (e.g., a capacitor capacity) and a power consumption of the power supply 150 as the sustainable time. The sustainable time may be divided for each activity. For example, a sustainable time for DL monitoring (e.g. monitoring of paging signals), a sustainable time for DL data reception, a sustainable time for UL data transmission, or the like may be used.

Third, the communication profile information may be adequately generated by the PIOT UE 100. The communication profile information may also be written in advance in a memory of the PIOT UE 100 (pre-configuration).

Fourth, the communication profile information may be represented by an identifier for each communication profile. That is, in the communication profile information, an identifier is assigned to each communication profile, and the communication profile information may have a different value depending on the identifier. For example, the identifier “1” of the communication profile information represents the communication profile information in which the communication available time period is “10 minutes” and the sustainable time is “30 minutes”. For example, the identifier “2” of the communication profile information represents the communication profile information in which the communication available time period is “15 minutes” and the sustainable time is “45 minutes”. The transmitting the communication profile information by using the identifier can reduce an amount of transmitted information compared to transmitting the communication profile information itself. This can reduce the power consumption of the PIOT UE 100. The identifier may be hard coded in the specification. The identifier may also be provided from the gNB 200 (or the CN 20) to the PIOT UE 100. The PIOT UE 100 can select an identifier of the optimum communication profile information according to communication characteristics of the PIOT UE 100 itself and transmit the identifier to the gNB 200 (or the CN 20).

Note that the communication profile information may include information specifying the type of downlink signaling from the gNB 200 to the PIOT UE 100. For example, the information can specify, for example, a NAS message or an RRC message.

The PIOT UE 100 may transmit the communication profile information in either an RRC message including the communication profile information or a NAS message including the communication profile information. Alternatively, the communication profile information may be transmitted by way of the MAC CE or UCI.

In step S11, the gNB 200 decides the transmission timing of the DL data to the PIOT UE 100 or the like based on the communication profile information. For example, the gNB 200 may perform the following processing. That is, the gNB 200, upon performing (or completing) the communication with the PIOT UE 100, starts a timer in which the communication available time period is set. The gNB 200 does not communicate with the PIOT UE 100 while the timer is running. The gNB 200 communicates with the PIOT UE 100 when the timer expires. Alternatively, the gNB 200 may adjust the DRX (or eDRX) parameters instead of the timer. The gNB 200 may perform communication with the PIOT UE 100 through the DRX (or eDRX). In this case, the gNB 200 may adjust the DRX parameters so that communication with the PIOT UE 100 is available during the communication available time period.

### Second Embodiment

A second embodiment is described.

A scenario is assumed in which the PIOT UE 100, near the gNB 200, communicates with the gNB 200. In such a scenario, the PIOT UE 100 may not need to adjust a Timing Advance value. The timing advance value is a value for adjusting the transmission timing for the UE so that signals from the UEs located at different distances can be received within a receive window of the gNB 200.

On the other hand, in the random access procedure, the gNB 200 calculates the TA value based on a reception timing of a preamble (PRACH) (MSG1) received from the UE. The gNB 200 notifies the UE of the TA value by transmitting a response message (MSG2) including the TA value to the UE. However, since the PIOT UE 100, when located near the gNB 200, may not need to adjust the TA value, the PIOT UE 100 can perform communication with the gNB 200 without performing the random access procedure.

Communication with the gNB 200 without performing the random access procedure may be referred to as “RACH-less communication”. The second embodiment describes the RACH-less communication by the PIOT UE 100.

### PUR

A Preconfigured uplink Resource (PUR) is similar to the RACH-less communication. The PUR has been specified in the LTE. The PUR is a technology in which a UE in an RRC idle state (such as a UE using enhanced Machine Type Communication (eMTC) or a UE using narrowband IoT (NB-IoT)) performs UL transmission using a pre-configured UL resource without performing the random access procedure. In the PUR, the UE uses a message 3 (MSG3) to transmit UL data transmission.

The PUR is triggered when the following three conditions are satisfied. First, a valid configuration for PUR (e.g., the UE has a valid PUR resource) is required to be configured. Second, the TA timer for PUR is required to be not expired (or be not set). Third, a difference between a past RSRP value and a current RSRP value is required to be equal to or less than a PUR variation threshold.

In the PUR, the UE uses the TA value without change. Then, the UE confirms that the distance to the gNB 200 is within an allowable range based on the PUR variable threshold, and performs the PUR.

### SDT

A Small Data Transmission (SDT) is similar to the RACH-less communication. The SDT is a technology in which a UE in an RRC inactive state enables data transmission (Mobile Originated (MO)) and data reception (Mobile Terminated (MT)).

The SDT supports a RACH-based SDT and a Configured Grant (CG)-based SDT. In the RACH-based SDT, the SDT is performed using the random access procedure. In the CG-based SDT, the SDT is performed using a configured resource without performing the random access procedure.

Not limited to the RACH-based SDT, in general, an RSRP threshold may be used to select a random access procedure by a 2-step RACH. Based on the RSRP threshold, either the random access procedure by the 2-step RACH or the random access procedure by a 4-step RACH is selected. The RSRP threshold is used to suppress a failure of the random access procedure due to the 2-step RACH. In the random access procedure by the 2-step RACH, the TA value is taken into account.

### Communication Control Method According to Second Embodiment

In the second embodiment, the gNB 200 transmits a RACH-less communication radio resource to the PIOT UE 100. Then, when an RSRP value of a received signal is equal to or greater than a determination RSRP value, the PIOT UE 100 performs RACH-less communication with the gNB 200 using the radio resource.

To be more specific, first, the base station (e.g., the gNB 200) transmits information regarding a radio resource that communication is available without performing the random access procedure to the user equipment (e.g., the PIOT UE 100) having a power supply that generates power using the energy harvesting. Second, the user equipment performs the communication with the base station by using the radio resource without performing the random access procedure when the received power of the received signal from the base station is equal to or greater than the determination RSRP threshold.

In this way, when the received power is equal to or greater than the determination RSRP threshold, the PIOT UE 100 can be assumed to be located near the gNB 200, thus the PIOT UE 100 communicates with the gNB 200 by using the radio resource received from the gNB 200 without performing the random access procedure. Therefore, the PIOT UE 100 can appropriately communicate with the gNB 200. In addition, since the PIOT UE 100 can communicate with the gNB 200 without performing the random access procedure, the power consumption can also be reduced.

Note that in the above-described PUR, a difference from a past RSRP value is used. Therefore, a memory (area) for storing the past RSRP value and arithmetic processing for comparing the past RSRP value with the current RSRP value are required. However, in the second embodiment, the past RSRP value is not used. Therefore, in the second embodiment, a memory capacity and the arithmetic processing can be reduced. Note that in the second embodiment, when the PIOT UE 100 performs RACH-less communication, the TA value is set to “0”. Therefore, the TA value may not need to be diverted as in the PUR.

The RSRP threshold value used in the 2-step RACH selection described above is used to suppress the failure of the random access procedure due to the 2-step RACH. In contrast, the determination RSRP threshold according to the second embodiment is used to confirm whether the PIOT UE 100 is located near the gNB 200. Therefore, the determination RSRP threshold according to the second embodiment is used for a purpose different from the RSRP threshold used in the 2-step RACH selection.

Note that as described above, the determination RSRP threshold is a threshold used for determining whether the PIOT UE 100 performs the random access procedure.

### Operation Example According to Second Embodiment

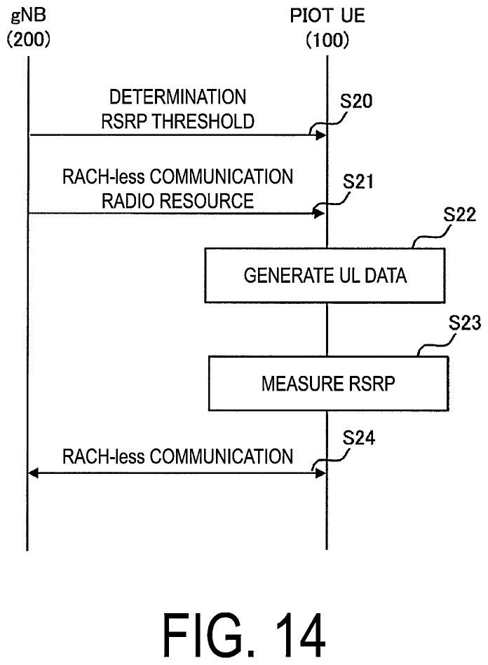

FIG. 14 is a diagram illustrating an operation example according to the second embodiment.

As illustrated in FIG. 14, in step S20, the gNB 200 transmits a determination RSRP threshold to the PIOT UE 100. The gNB 200 transmits the determination RSRP threshold included in a system information block (SIB) or an RRC message (dedicated signaling). Alternatively, the determination RSRP threshold may be pre-configured for the PIOT UE 100. Alternatively, the determination RSRP threshold indicating that the random access procedure may not need to be performed may be pre-configured for the PIOT UE 100. Alternatively, when the PIOT UE 100 is permitted to perform RACH-less communication (e.g., when RACH-less communication is pre-configured), the PIOT UE 100 may not need to transmit the determination RSRP threshold or may not need to receive the determination RSRP threshold. The PIOT UE 100 may determine the start of RACH-less communication based on pr-configured permission information. The following description is given assuming that a determination RSRP threshold is transmitted from the gNB 200 and then received by the PIOT UE 100.

In step S21, the gNB 200 transmits information regarding a RACH-less communication radio resource to the PIOT UE 100. That is, the gNB 200 transmits the information regarding the radio resource that communication is available without performing the random access procedure to the PIOT UE 100. The gNB 200 transmits the information regarding the radio resource included in a system information block (SIB) or an RRC message (dedicated signaling).

In step S22, the PIOT UE 100 generates UL data. For example, the AS layer of the PIOT UE 100 receives UL data from a higher layer (e.g., an application layer, or the like). The PIOT UE 100 may receive a paging message (or a reader signal) from the gNB 200. The latter is on the premise that the PIOT UE 100 is in the RRC idle state or an RRC inactive state.

In step S23, the PIOT UE 100 measures received power (RSRP) of a signal (i.e., a reference signal) transmitted from the gNB 200. The PIOT UE 100 compares the measurement result with the determination RSRP threshold.

Here, when [measurement result]<[determination threshold] holds, the PIOT UE 100 determines that the random access procedure is required. In this case, the PIOT UE 100 initiates a random access procedure. Alternatively, the PIOT UE 100 does not perform data transmission. When [measurement result]<[determination threshold] holds, the PIOT UE 100 performs a normal random access procedure because a distance from the gNB 200 is equal to or greater than a certain distance.

On the other hand, when [measurement result]≥[determination threshold] holds, the PIOT UE 100 determines that the random access procedure is not required. At this time, the PIOT UE 100 sets the TA value to “0”. The PIOT UE 100 determines that the distance from the gNB 200 is within a certain range and thus the TA value does not need to be adjusted, and sets the TA value to “0”. The PIOT UE 100 selects the RACH-less communication radio resource received in step S21. The following description is given on the assumption of [measurement results]≥[determination thresholds].

Then, in step S24, the PIOT UE 100 starts the RACH-less communication using the RACH-less communication radio resource without performing the random access procedure. For example, the PIOT UE 100 may transmit a message 3 (MSG3). The PIOT UE 100 may transmit data.

### Other Embodiments

A program causing a computer to execute each of the processes performed by the UE 100 (the PIOT UE 100) or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 (PIOT UE 100) or the gNB 200 may be integrated, and at least a part of the UE 100 (PIOT UE 100) or the gNB 200 may be implemented as a semiconductor integrated circuit (a chipset or a System on a chip (SoC)).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on”. The terms “include”, “comprise”, and variations thereof do not mean “include only items stated”, but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. All or some of the embodiments, operations, processes, and steps may be combined without being inconsistent.

### Supplementary Note

Features relating to the embodiments described above are described below as supplements.
   (1)
A communication control method in a wireless communication system, the communication method including:
a step of transmitting, by a user equipment, communication profile information indicating a time period when communication with a base station is available to the base station, the user equipment having a power supply that generates power using energy harvesting; and
a step of performing, by the base station, the communication with the user equipment based on the communication profile information.
   (2)
The communication control method according to (1) above, wherein
the communication profile information is a communication available time period representing a time period from when the user equipment ends communication to when next communication is available and/or a sustainable time period representing a communication time period sustainable by the user equipment in one communication.
   (3)
The communication control method according to (1) or (2) above, wherein
the communication profile information is represented by an identifier for each piece of the communication profile information.
   (4)
A communication control method in a wireless communication system, the communication method including:
a step of transmitting, by a base station, information regarding a radio resource that communication is available without performing a random access procedure to a user equipment having a power supply that generates power using energy harvesting;
a step of performing, by the user equipment, the communication with the base station by using the radio resource without performing the random access procedure when received power of a received signal from the base station is equal to or greater than a determination RSRP threshold.
   (5)
The communication control method according to (4) above, wherein
the step of performing the communication includes setting, by the user equipment, a timing advance value to “0”.

### REFERENCE SIGNS

1: Wireless communication system
10: NG-RAN
20: 5GC (CN)
30: AMF
100: PIOT UE
110: Receiver
120: Transmitter
130: Controller
140: Reader/writer
141: RFID antenna
200: gNB
210: Transmitter
220: Receiver
230: Controller
250: Reader/writer
251: RFID antenna
300: Wireless tag
310: RFID antenna
320: Controller
330: Memory
340: Power supply

1. A communication control method in a wireless communication system, the communication method comprising:
transmitting, by a user equipment, communication profile information indicating a time period when communication with a network node is available to the network node, the user equipment comprising a power supply configured to generate power using energy harvesting; and
performing, by the network node, the communication with the user equipment based on the communication profile information.

2. The communication control method according to claim 1, wherein
the communication profile information is a communication available time period representing a time period from when the user equipment ends communication to when next communication is available and/or a sustainable time period representing a communication time period sustainable by the user equipment in one communication.

3. The communication control method according to claim 1, wherein
the communication profile information is represented by an identifier for each piece of the communication profile information.

4. A user equipment in a wireless communication system, the user equipment comprising:
a power supply configured to generate power using energy harvesting;
a transmitter circuitry configured to transmit communication profile information indicating a time period when communication with a network node is available to the network node; and
processing circuitry configured to perform the communication with the network node based on the communication profile information.

5. A communication control method in a wireless communication system, the communication method comprising:
transmitting, by a network node, information regarding a radio resource that communication is available without performing a random access procedure to a user equipment comprising a power supply configured to generate power using energy harvesting;
performing, by the user equipment, the communication with the network node by using the radio resource without performing the random access procedure when received power of a received signal from the network node is equal to or greater than a determination RSRP threshold.

6. The communication control method according to claim 5, wherein
the performing the communication comprises setting, by the user equipment, a timing advance value to “0”.
